(19) United States
(12) Patent Application Publication
(10) Pub. No.: US 2008/0302548 A1
(43) Pub. Date: Dec. 11, 2008

(54) Percussion Hammer and/or Drill Hammer Comprising a Safety Coupling

(75) Inventors: Rudolf Berger, Grunwald (DE); Wolfgang Schmid, Munchen (DE)

Correspondence Address: BOYLE FREDRICKSON S.C., 840 North Plankinton Avenue, MILWAUKEE, WI, 53203, US

(73) Assignee: WACKER CONSTRUCTION EQUIPMENT AG, Munchen (DE)

(21) Appl. No.: 11/572,122

(22) PCT Filed: Jul. 13, 2005
(86) PCT No.: PCT/EP05/07637

§ 371 Date: Aug. 8, 2008

(30) Foreign Application Priority Data
Jul. 15, 2004 (DE) 10 2004 034 268.7

(51) Int. Cl. B23Q 5/00

(52) U.S. Cl. 173/5

(57) ABSTRACT

A safety coupling in a percussion hammer and/or drill hammer, comprising a basic sleeve, a driven toothed wheel that is rotatably mounted on the basic sleeve and can be driven by a drive unit, a closing ring which is fastened to the basic sleeve, and a locking ring located between the driven toothed wheel and the closing ring. Said locking ring is fixed in a torsion-proof manner relative to the closing ring while being movable relative to the closing ring in an axial direction, counter to the effect of a spring mechanism. The locking ring is axially displaced while the driven toothed wheel remains in the axial position thereof when a threshold torque is exceeded.

### BACKGROUND OF THE INVENTION

1. Field of the Invention

The present invention relates to a percussion hammer and/or drill hammer that is equipped with a safety coupling.

2. Description of the Related Art

In particular during drilling, in percussion and/or drill hammers (called “hammers” for brevity hereinafter) there is the danger that the drill or drill bit will become lodged upon impact in the stone that is being worked, which can result in a significant increase in the effective torques in the hammer, causing damage to the drive train. Moreover, the torques must be manually supported by the operator, so that in heavier devices a sudden blocking of the drilling tool can result in the hammer being torn from the operator's hand. For this reason, in known hammers a safety coupling is built into the torque flow, which interrupts the torque flow acting in the device when a predetermined boundary torque value is exceeded. In this way, an excessive torque that may occur will no longer have a damaging effect on the drive or on the operator.

In its many different technical realizations, the safety coupling can be situated at various locations inside the device in the flow of force or torque, in particular in the flow of torque between a drive of the hammer (e.g. an electric motor or internal combustion engine) and a tool holder that holds the tool. Installation locations situated between a crankshaft belonging to the drive and a drill shaft that accepts the tool holder or is connected before the tool holder have turned out to be particularly suitable.

Safety couplings can be constructed in many different ways. In practice, what are known as latch or claw safety couplings have turned out to be particularly advantageous that are situated in the area of the drive shaft or of a percussion mechanism tube belonging to a percussion mechanism of the hammer. Standardly, a toothed drive wheel attached to the drill shaft or to the percussion mechanism tube and provided with latches or claws on its front side is pressed by an engaging spring against a collar that is also provided with latches and that is connected integrally to the percussion mechanism tube or the drill shaft. Safety couplings of this sort can be manufactured economically and are robust and durable, because when actuated the rotational speeds are low, and at the location of installation there is a large diameter and sufficient space for generous dimensioning.

FIG. 8 shows a section through a typical drill hammer, as is for example known from DE 101 45 464 A1. The torque of an electric motor 1 that acts as a drive is transmitted via a multiplicity of toothed wheels and a crankshaft 2 to a main shaft 3, and is finally transmitted via additional toothed wheels to a drill shaft 4 that holds a tool holder 5, in which a drill and/or chisel tool (not shown) can be inserted.

In main shaft 3 there is integrated a safety coupling 6 that has a toothed disk 8 supported by a spring 7. When a prespecified boundary torque value is exceeded, there arises at the teeth of toothed disk 8 axial forces that are large enough to press toothed disk 8 back against the action of spring 7. This results in an interruption of the torque flow, so that danger to the operator of the hammer, e.g. given a blocking of the drill tool during drilling, is avoided.

From DE 42 15 288 A1, a drill hammer is known that has a safety coupling in which the toothed drive wheel situated on the safety coupling must be displaced axially against the action of a spring in order to bring it out of engagement with its paired mating gear, and thus to interrupt the torque flow. As long as the hammer is new, this is unproblematic. However, in older devices there is the danger that after longer periods of use, due to wear the toothed drive wheel will run together with the toothed mating gear in such a way that the drive wheel can no longer be axially displaced. If this has happened, a desired response of the safety coupling when the boundary torque value is exceeded is no longer ensured.

In addition, drill hammers can often be switched between a plurality of operating modes. Besides a pure drilling mode (with the percussion mechanism switched off) and a drill hammer operation (drilling and chiseling), a pure chiseling operation is also possible in which the tool is not rotationally driven. In known hammers, the chisel is then however freely rotatable in an uncontrolled fashion, which can be disadvantageous when guiding the device as a whole.

### OBJECT OF THE INVENTION

The present invention is based on the object of indicating a percussion and/or drill hammer having a safety coupling that is improved with respect to its resistance to wear, reliability, and functionality.

According to the present invention, this object is achieved by a percussion and/or drill hammer as recited in patent claim 1. Advantageous constructions of the present invention are defined in the dependent claims.

The percussion and/or drill hammer according to the present invention is equipped with a safety coupling that has a toothed drive wheel capable of being driven by the drive with the torque, a sealing ring situated axially to the toothed drive wheel and via which the torque can be guided, and a latch device situated between the toothed drive wheel and the sealing ring. In a normal operating state, the latch device ensures a flow of torque between the toothed drive wheel and the sealing ring. In an overload state, in which a torque exceeding a prespecified boundary torque value is introduced into the safety coupling, the latch device interrupts the torque flow between the toothed drive wheel and the sealing ring.

The axial situation of the toothed drive wheel and the sealing ring with the latch device situated axially between them makes it possible to realize the safety coupling in such a way that at least the axial position of the toothed drive wheel need not be modified even in the overload state. Rather, the latch device takes over the function of interrupting the torque flow, through axial displacement.

The toothed drive wheel can remain at all times in its intended axial position, and can thus mesh with its allocated mating gear even in case of overload. The problems that occur in the prior art of a mutual running together of the toothed drive wheel and the mating gear, and the resulting limited reliability of the safety coupling, are avoided in this way.

Particularly advantageously, it can be ensured that the axial position of the toothed drive wheel need not be modified if at least a part of the latch device is capable of axial movement relative to the sealing ring and/or relative to the toothed drive wheel. This makes possible for example a realization in which only the latch device, or a part thereof, executes an axial movement, e.g. in the overload state, while the other components of the safety coupling remain in their axial position.

Preferably, the axial position of the toothed drive wheel and/or of the sealing ring is fixed in at least one axial direction. A movement of the toothed drive wheel or of the sealing ring in the opposite axial direction can be permissible under some circumstances, but should then be possible only against the action of a spring. This enables various constructions of the safety coupling.

It is particularly advantageous if the toothed drive wheel and the sealing ring are situated on a base sleeve. This design of the safety coupling enables a compact construction in which the safety coupling can be preassembled before being installed in the hammer.

In a particularly advantageous specific embodiment of the present invention, the toothed drive wheel is mounted on the base sleeve so as to be capable of rotation, while the sealing ring is fastened to the base sleeve or is fashioned in one piece with the base sleeve.

In another specific embodiment of the present invention, this design can be reversed, so that the sealing ring is mounted on the base sleeve so as to be capable of rotation, while the toothed drive wheel is fixedly attached to the base sleeve. Finally, a variant is also possible in which both the toothed drive wheel and also the sealing ring are rotatably mounted on the base sleeve.

In a particularly advantageous specific embodiment of the present invention, the latch device has a latch ring situated between the toothed drive wheel and the sealing ring. The latch ring is rotationally fixed relative to the sealing ring, and is capable of being axially displaced against the action of a spring device. The toothed drive wheel and the latch ring have a mutually engaging latch toothing via which the torque that is to be transmitted by the safety coupling is conducted. In the normal operating state, the latch ring is pressed axially against the toothed drive wheel by the spring device, so that the latch toothings engage with one another. In the overload state, the latch ring is pushed in the direction of the sealing ring axially against the action of the spring device, so that the latch toothings of the latch ring and the toothed drive wheel disengage from one another.

In a particularly advantageous construction of the present invention, the latch toothings each have beveled side edges (viewed in the circumferential direction) via which the torque to be transmitted by the safety coupling is transmitted. Through the beveled side edges, an axial force directed against the action of the spring device is constantly produced on the latch ring. If in the overload state the effective torque exceeds the prespecified boundary torque value, the axial force becomes large enough that it axially pushes the latch ring in the direction of the sealing ring, against the action of the spring device, so that the latch toothings disengage from one another.

In a particularly advantageous construction of the present invention, the sealing ring and the latch ring each have entraining claws that constantly engage with one another. In this way, the sealing ring and the latch ring are rotationally fixed to one another in the circumferential direction. In contrast, in the axial direction the latch ring is capable of being moved relative to the sealing ring. The entraining claws can be constructed in a stable fashion, so that they also reliably transmit the torque when the latch ring is in its position furthest from the sealing ring.

Preferably, the toothed drive wheel is axially mounted or supported at least on a side of the base sleeve facing away from the latch claws. In this way, an expensive separate mounting of the toothed drive wheel can be avoided. An axial mounting on the side of the latch claws, in contrast, is not required, because on this side the toothed drive wheel is constantly supported by the latch ring and the spring device acting behind it.

Another specific embodiment of the present invention presents a kinematic reversal of the above-described specific embodiment. According to this embodiment, the latch ring situated between the toothed drive wheel and the sealing ring is rotationally fixed relative to the toothed drive wheel, and is capable of axial displacement relative to the toothed drive wheel, against the action of a spring device. In contrast to the above-described specific embodiment, the latch toothings are not formed between the toothed drive wheel and the latch ring, but rather between the sealing ring and the latch ring. Accordingly, the sealing ring has a latch toothing on a front side facing the latch ring, while the latch ring has a latch toothing that fits the latch toothing of the sealing ring on a side facing the sealing ring. Via the spring device, the latch ring is supported not against the sealing ring, but against the toothed drive wheel. In the normal operating state, the latch ring is pressed against the sealing ring in such a way that the latch toothings engage with one another. In contrast, in the overload state the latch ring is axially displaced in the direction of the toothed drive wheel, so that the latch toothings disengage.

In another advantageous construction of the present invention, the base sleeve is an integral component of the drill shaft or is a part of a percussion mechanism tube. This means that the base sleeve need not necessarily be a separate additional component. Rather, it is possible to construct the toothed drive wheel, the sealing ring, and the latch device on an already-present component in the hammer, in particular the drill shaft, the percussion mechanism tube, or another shaft situated in the torque flow. However, a separate base sleeve has the advantage of a particularly simple preassembly outside the hammer.

It is particularly advantageous that the safety coupling can be completely preassembled and then pushed with its base sleeve onto a bearer sleeve so as to be capable of rotational movement. The bearer sleeve can be a part of a drill shaft and/or a part of a percussion mechanism or percussion mechanism tube. In principle, the safety coupling according to the present invention can be used in any kind of percussion and/or drill hammer, so that the bearer sleeve can be used at a suitable location.

In a particularly advantageous construction of the present invention, on the bearer sleeve there is provided an axially displaceable switching ring with which the flow of torque from the safety coupling to the bearer sleeve can be created or interrupted. The switching ring is used to preset various operating states of the hammer, as is explained in more detail below.

The switching ring is preferably connected in rotationally fixed fashion to the bearer sleeve, and has on one side switching claws to which there are allocated oppositely situated switching claws provided on a rear side of the sealing ring. Thus, the switching claws of the switching ring can be brought into engagement with the switching claws of the sealing ring, so that the flow of torque can be transmitted from the sealing ring via the switching claws to the switching ring, and from the switching ring to the bearer sleeve.

In a particularly preferred specific embodiment of the present invention, the switching ring can be displaced at least between a drilling position in which the switching claws of the switching ring are engaged with the switching claws of the sealing ring, and a free rotation position in which the switching claws are not engaged. In the drilling position, of course, impacts from the percussion mechanism provided in the hammer can also be exerted on the tool, so that the term “drilling position” also includes a “drilling/chiseling position.” In contrast, in the free rotation position no drilling torque is transmitted to the tool. Rather, the tool is then capable of unhindered rotation relative to the hammer, for example if the operator correspondingly pivots the hammer. The free rotation position is standardly used before chiseling in order to bring a chisel cutting edge into a suitable angular rotational position relative to the hammer housing.

In a particularly advantageous construction of the present invention, the switching ring is also capable of being moved into a fixing position (chiseling position) in which fixing claws that are attached to the switching ring on a rear side opposite the front side are brought into engagement with oppositely situated fixing claws provided on a fixing ring that is fixedly attached to the housing. Thus, in the fixing position the switching ring, and consequently also the bearer sleeve, are fixed relative to the hammer housing. A rotation of the bearer sleeve or of the drill shaft, and thus of the tool, relative to the hammer is then not possible. The fixing position is used by the operator during pure chiseling work (without drilling).

These and other advantages and features of the present invention are explained in more detail below in relation to an example, with the aid of the accompanying Figures.

### BRIEF DESCRIPTION OF THE DRAWINGS

FIG. 1 shows a section through a safety coupling according to the present invention for a percussion and/or drill hammer;

FIG. 2 shows a perspectival exploded view of the safety coupling of FIG. 1;

FIG. 3 shows the exploded view of FIG. 2 from a different perspective;

FIG. 4 shows a section having a safety coupling built onto a percussion mechanism tube;

FIG. 5 shows an external view of FIG. 4;

FIG. 6 shows a perspective exploded view of FIGS. 4 and 5;

FIG. 7 shows a section through another specific embodiment of the safety coupling according to the present invention; and

FIG. 8 shows a section through a percussion and/or drill hammer according to the prior art.

### DETAILED DESCRIPTION OF THE PREFERRED EMBODIMENT

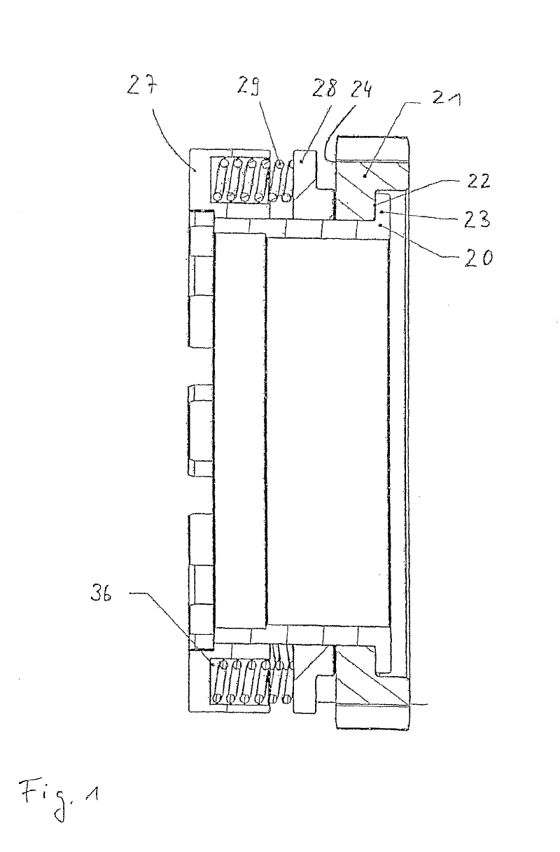

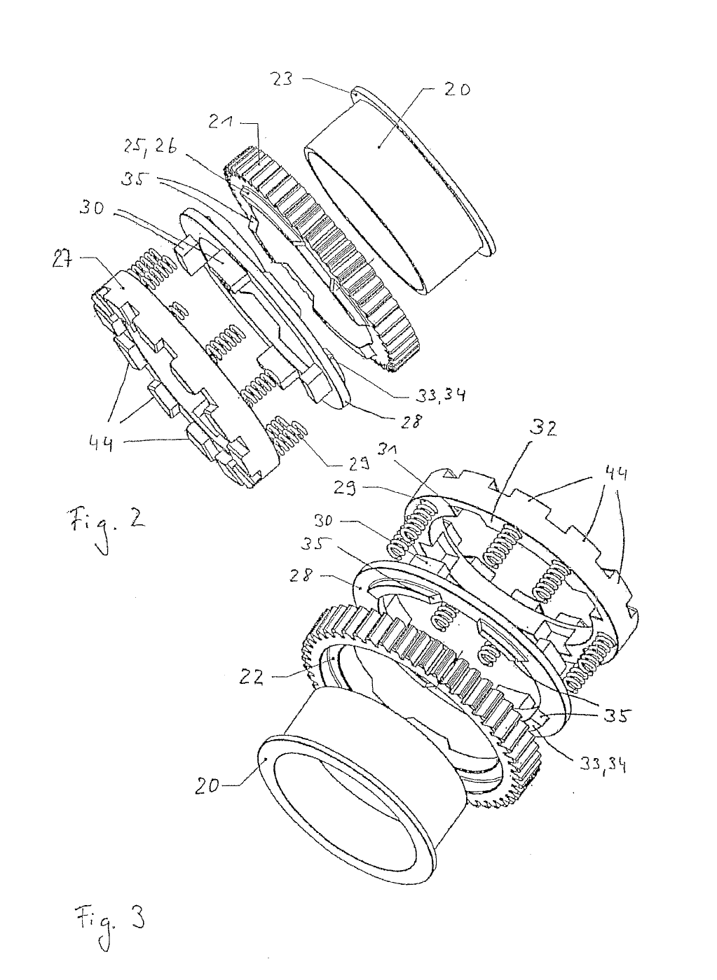

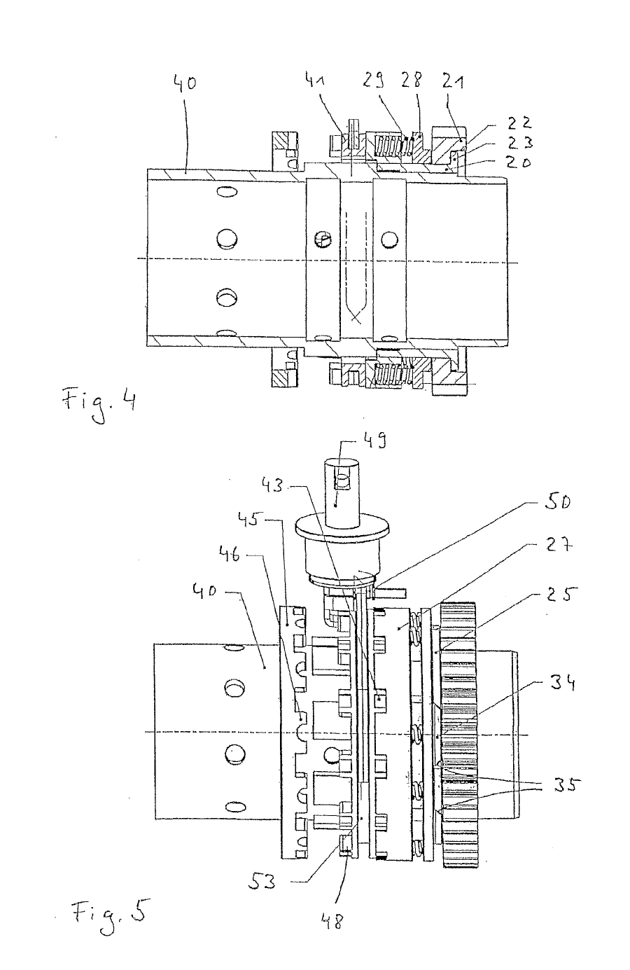

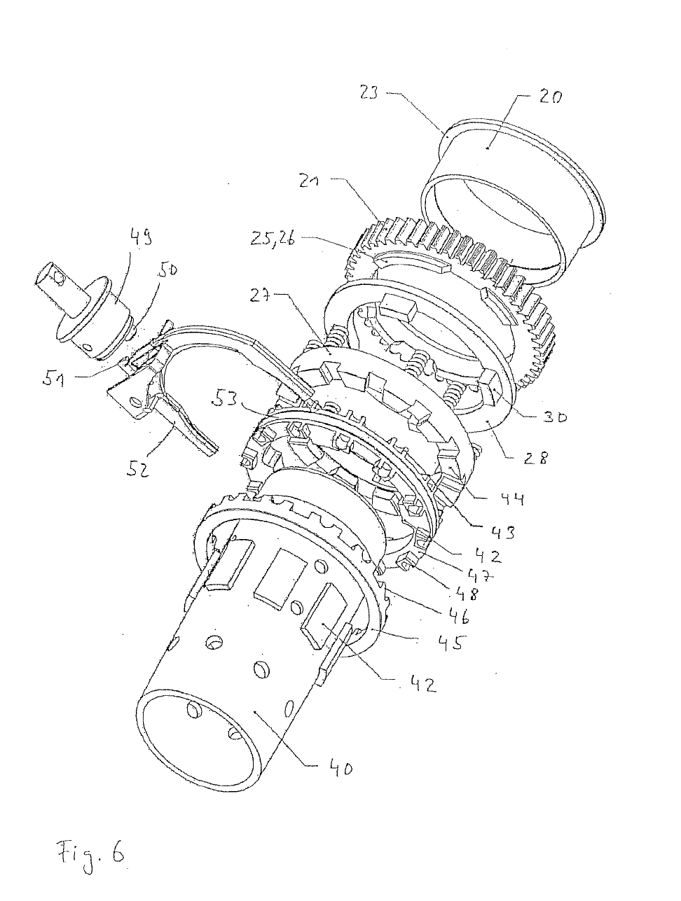

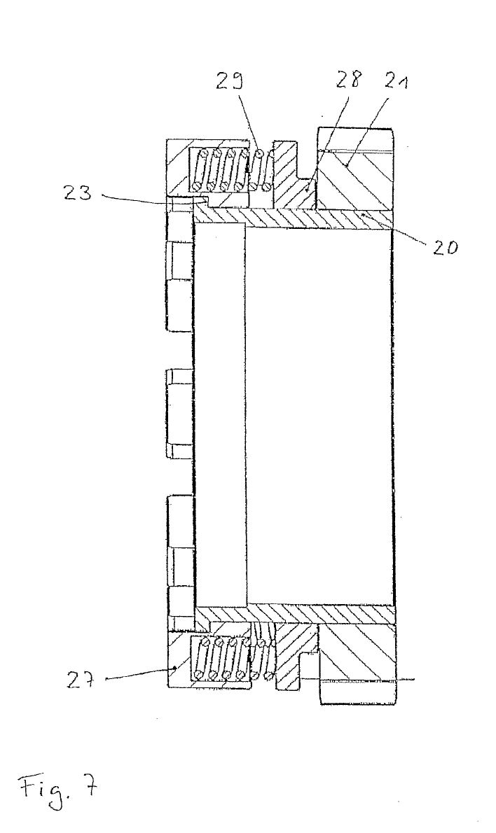

FIGS. 1 to 3 show a safety coupling according to the present invention in sectional or exploded view.

On a base sleeve 20, a toothed drive wheel 21 is situated that is supported with its smooth sliding surface 22 against a corresponding collar 23 of base sleeve 20. Toothed drive wheel 21 can rotate freely relative to base sleeve 20 and meshes with a mating gear (not shown), from which the drive torque of a drive (not shown) is introduced. On a side 24 situated opposite sliding surface 22, toothed drive wheel 21 has a plurality of radially offset latch claws 25 of a latch toothing 26 (see FIG. 2).

On the end of base sleeve 20 situated opposite collar 23, a sealing ring 27 is fixedly placed, for example by a press-fit seating. Of course, sealing ring 27 can also be fastened to base sleeve 20 in some other way, e.g. by screwing, or can be fashioned in one piece with the sleeve.

Between sealing ring 27 and toothed drive wheel 21, there is situated a latch ring 28 that is capable of axial displacement and that is pressed axially against toothed drive wheel 21 by a plurality of springs 29 that are supported against sealing ring 27. Latch ring 28 bears a plurality of entraining claws 30 that extend axially and that engage in corresponding grooves 31 between allocated entraining claws 32 of sealing ring 27. Correspondingly, it is possible for latch ring 28 to be displaced axially by springs 29, or against the action of springs 29, entraining claws 30 of latch ring 28 remaining at all times engaged with entraining claws 32 of sealing ring 27, so that a torque can be transmitted.

Latch ring 28 has on a side facing toothed drive wheel 21 a plurality of latch claws 33 that form a latch toothing 34. Latch toothing 26 of toothed drive wheel 21 and latch toothing 34 of latch ring 28 are fashioned such that latch claws 25 and latch claws 33 are able to engage in one another in at least one particular relative rotational position of toothed drive wheel 21 and latch ring 28. Individual latch claws 25 or 33 can have different or asymmetrical widths in the circumferential direction (angular extensions), so that latch claws 25, 33 can latch into one another less frequently than would be possible in principle based on the number of intermediate spaces between latch claws 25, 33. This prevents rattling of the safety coupling and reduces wear in the case of overload. On the other hand, the increased number of latch claws 25, 33 results in a plurality of latch locations, so that the torque can be reliably transmitted.

Latch claws 25, 33 each have beveled side edges 35 via which the force or torque flow is guided between toothed drive wheel 21 and latch ring 28. Due to their oblique position, side edges 35 each also produce axial forces that push toothed drive wheel 21 and latch ring 28 away from one another. Because toothed drive wheel 21 is supported against collar 23, however, it cannot move axially, but rather always remains in the desired axial position, in which it meshes with the mating gear (not shown). In contrast, latch ring 28 is capable of axial displacement, as shown above.

When the torque introduced into toothed drive wheel 21 exceeds a particular boundary value (boundary torque), the axial forces caused by beveled side edges 35 become large enough that latch ring 28 is pressed back in the direction of sealing ring 27, against the action of spring 29. This causes latch toothings 26 and 34 to disengage, so that further transmission of the torque is prevented. The safety coupling is then in the overload state, and fulfills its intended function of protecting the drive train and the operator manually holding the hammer. Accordingly, in the overload state latch ring 28 is pressed by beveled lateral edges 35 against sealing ring 27 in such a way that latch toothings 26 and 34 disengage. Springs 29, however, continuously press latch ring 28 back in order to bring it into engagement with latch toothing 26 of toothed drive wheel 21. If the torque to be transmitted is still greater than the boundary torque value, latch ring 28 is again subjected to an increased axial force that again presses it back against sealing ring 27. Correspondingly, the safety coupling in the case of overload will rattle until the operator interrupts the operation of the hammer.

In the specific embodiment shown in FIGS. 1 to 3, springs 29 are largely placed in bores 36 that are essentially formed in entraining claws 32 of sealing ring 27. Alternatively, however, it is also possible for springs 29 to be placed in corresponding bores in entraining claws 30 of latch ring 28. This would even enable an enlargement of the axial width of latch ring 28, which would improve its axial gliding properties on base sleeve 20.

The safety coupling shown in FIGS. 1 to 3 represents a self-sufficient assembly that can be preassembled outside the hammer. The assembly can then easily be installed in the hammer as a unified component.

FIGS. 4, 5, and 6 show the safety coupling in the installed state, i.e., pushed onto a bearer sleeve 40. FIG. 4 shows a section. In FIG. 5, a side view corresponding to the section of FIG. 4 is shown, while FIG. 6 shows the system in a perspective exploded view.

Bearer sleeve 40 can be part of a drill shaft. In the example shown in FIGS. 4 to 6, bearer sleeve 40 is a percussion mechanism tube inside which a known pneumatic spring hammer mechanism (not shown in the Figures) is situated. Pneumatic spring hammer mechanisms are based on the principle that a drive piston that is capable of axial back-and-forth movement, e.g. driven by a crankshaft, drives an impact piston situated in front of the drive piston back and forth via an air spring. The impact piston in turn cyclically transmits its impact energy to a tool. Because pneumatic spring hammer mechanisms of this sort are known in many realizations, a more detailed description is not necessary here.

If bearer sleeve 40 is fashioned as a drill shaft, it can accept a complete hammer mechanism, in particular including a hammer mechanism tube, or else can itself form the hammer mechanism tube or housing, as shown in FIGS. 4 to 6.

In the specific embodiment shown in FIGS. 4 to 6, it is necessary for the hammer mechanism tube to take over the function of a drill shaft, and correspondingly to execute an entrained rotation in order to transmit the torque.

For this purpose, on bearer sleeve 40 there is situated a switching ring 41 that is capable of axial displacement and that is connected in rotationally fixed fashion to bearer sleeve 40 via wedges 42. Switching ring 41 acts to create or interrupt the flow of torque from the safety coupling to bearer sleeve 40. On a front side of switching ring 41, switching claws 43 are provided to which there are allocated oppositely situated switching claws 44 that are situated on a rear side of sealing ring 27. Switching claws 44 are also clearly visible in FIGS. 1 to 3.

In the position of switching ring 41 shown in FIGS. 4 and 5, switching ring 41 assumes what is called a drilling position, in which switching claws 43 of switching ring 41 engage with switching claws 44 of sealing ring 27, so that the torque introduced via toothed drive wheel 21 can be transmitted to bearer sleeve 40 via sealing ring 27, switching ring 41, and wedge toothing 42. From bearer sleeve 40, the torque is transmitted in a known manner (not shown) to a tool (also not shown).

If, in contrast, switching ring 41 is displaced axially on bearer sleeve 40 in such a way that switching claws 43, 44 disengage, what is known as a free rotational position is achieved, in which no torque is introduced to bearer sleeve 40. Rather, bearer sleeve 40 can rotate freely together with switching ring 41.

Finally, another fixing ring 45 is provided that is fastened to a housing (not shown) of the hammer. On fixing ring 45, fixing claws 46 are fashioned on the front side, to which fixing claws 48 are allocated that are oppositely situated on a rear side 47 of switching ring 41. Switching ring 41 is correspondingly able to be displaced into a fixing position (not shown in the Figures) in which fixing claws 48 of switching ring 41 engage with fixing claws 46 of fixing ring 45. In this fixing position, no torque is introduced to bearer sleeve 40 by the drive. However, bearer sleeve 40 cannot rotate freely, because its position relative to the housing is fixed.

The axial displacement of switching ring 41 takes place with the aid of a switching lever 49 that is accessible from the outside by the operator, and which for example can also be realized as a rotary switch, as is shown in particular in FIG. 6. The rotational position of switching lever 49 is transmitted via a switching cam 50 and a known switching spring 51 to a switching fork 52 that engages in a circumferential groove 43 in the outer area of switching ring 41. Through switching spring 51, it is possible in particular for an axial force to be exerted on switching claws 43, if for example switching claws 43 of switching ring 41 are situated over switching claws 44 of sealing ring 27, so that when there is further rotation of switching ring 41 relative to sealing ring 27, switching claws 43 can finally move into engagement. For the operator, this means increased ease of operation, because the operator can use switching lever 49 to preselect the desired operating mode, and to place the device automatically into the desired operating mode via the spring pre-tension of switching spring 41.

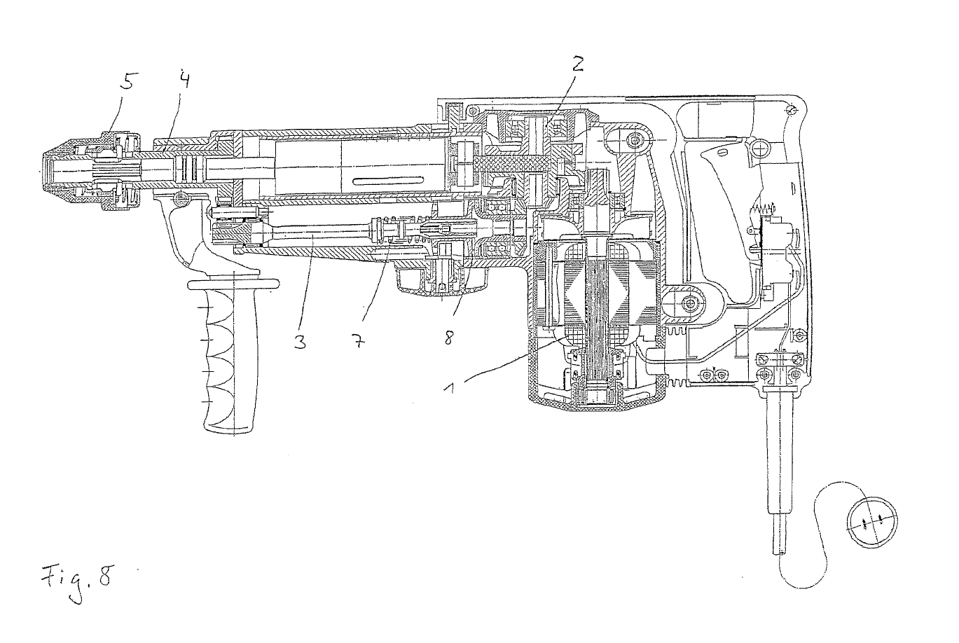

FIG. 7 shows another specific embodiment of the safety coupling according to the present invention in a sectional view.

Because the safety coupling corresponds in its design to the safety coupling shown in FIG. 1, for simplicity identical reference characters are used. However, differing from the safety coupling of FIG. 1, here toothed drive wheel 21 is attached fixedly to base sleeve 20. In contrast, sealing ring 27 is capable of radial rotation on base sleeve 20. It is supported axially against collar 23, and the action of springs 29 secures the axial position of sealing ring 27 against collar 23. Springs 29 are in turn supported via latch ring 28 against toothed drive wheel 21, which is fastened on base sleeve 20.

The further functioning of the safety coupling, in particular the latch device having latch ring 28 and springs 29, corresponds to the design explained above with reference to FIGS. 1 to 3, so that repetition here is not necessary.

In another specific embodiment of the present invention (not shown), both toothed drive wheel 21 and sealing ring 27 can be situated on base sleeve 20 so as to be capable of free rotation; here one collar 23, as shown in FIGS. 1 and 7, must be provided for each of elements 21, 27. Springs 29, together with latch ring 28, ensure that both latch ring 27 and toothed drive wheel 21 are pressed against their respectively allocated collar 23, so that the respective axial position is ensured.

Although the safety couplings shown in the Figures each have a base sleeve 20, for the realization of the present invention it is not required to provide such a base sleeve 20. Rather, it is also possible to construct toothed drive wheel 21, sealing ring 27, and the latch device comprising latch ring 28 and springs 29 at a suitable location, e.g. on the drill shaft, without an additional base sleeve 20.

1. A percussion and/or drill hammer, comprising;
a drive;
a drill shaft driven by the drive with a torque; and
a safety coupling situated in the flow of torque between the drive and the drill shaft; the safety coupling having:
a toothed drive wheel that is capable of being driven by the drive with the torque;
a sealing ring that is situated axially to the toothed drive wheel and via which the torque can be guided; and
a latch device situated between the toothed drive wheel and the sealing ring, wherein
in a normal operating state, the latch device ensures a flow of torque between the toothed drive wheel and the sealing ring; wherein
in an overload state, in which a torque exceeding a prespecified boundary torque value is introduced into the safety coupling, the latch device interrupts the flow of torque between the toothed drive wheel and the sealing ring; and wherein
the latch device has a latch ring that is situated between the toothed drive wheel and the sealing ring and that is capable of being axially displaced against the action of a spring device, and that, depending on its axial position, ensures or interrupts the flow of torque;
the latch ring is rotationally fixed relative to the sealing ring, and is capable of being axially displaced relative to the sealing ring against the action of the spring device;
the toothed drive wheel has a latch toothing on a side facing the latch ring;
the latch ring has, on a side facing the toothed drive wheel, a latch toothing that fits the latch toothing of the toothed drive wheel;
in the normal operating state, the latch ring is pressed axially against the toothed drive wheel by the spring device in such a way that the latch toothings engage in one another; and
in the overload state, the latch ring is axially displaced in the direction of the sealing ring, and the latch toothings disengage.

2. The percussion and/or drill hammer as recited in claim 1, wherein
the latch toothings each have, seen in the circumferential direction, beveled lateral edges via which the torque that is to be transmitted by the safety coupling is transmitted from the toothed drive wheel to the latch ring; and
in the overload state, the beveled lateral edges produce an axial force directed against the action of the spring device in such a way that the latch ring is axially displaced in the direction of the sealing ring and the latch toothings disengage.

3. The Percussion and/or drill hammer as recited in claim 1, wherein the sealing ring and the latch ring each have entraining claws that constantly engage in one another in such a way that the sealing ring and the latch ring are fixed with one another in the circumferential direction, but are capable of being displaced towards one another in the axial direction.

4. The percussion and/or drill hammer as recited in claim 1 wherein
the toothed drive wheel is borne axially by a base sleeve at least on a side facing away from its latch toothing.

5. A percussion and/or drill hammer, comprising:
a drive;
a drill shaft driven by the drive with a torque; and
a safety coupling situated in the flow of torque between the drive and the drill shaft; the safety coupling having:
a toothed drive wheel that is capable of being driven by the drive with the torque;
a sealing ring that is situated axially to the toothed drive wheel and via which the torque can be guided; and
a latch device situated between the toothed drive wheel and the sealing ring, wherein
in a normal operating state, the latch device ensures a flow of torque between the toothed drive wheel and the sealing ring; and in which
in an overload state, in which a torque exceeding a prespecified boundary torque value is introduced into the safety coupling, the latch device interrupts the flow of torque between the toothed drive wheel and the sealing ring; and wherein
the latch device has a latch ring that is situated between the toothed drive wheel and the sealing ring and that is capable of being axially displaced against the action of a spring device, and that, depending on its axial position, ensures or interrupts the flow of torque;
the latch ring is rotationally fixed relative to the toothed drive, and is capable of being axially displaced relative to the toothed drive wheel against the action of a spring device;
the sealing ring has a latch toothing on a side facing the latch ring;
the latch ring has, on a side facing the sealing ring, a latch toothing that fits the latch toothing of the sealing ring;
in the normal operating state, the latch ring is pressed axially against the sealing ring by the spring device in such a way that the latch toothings engage in one another; and
in the overload state, the latch ring is axially displaced in the direction of the toothed drive wheel, and the latch toothings disengage.

6. The percussion and/or drill hammer as recited in claim 5, wherein
seen in the circumferential direction, the latch toothings each have beveled lateral edges via which the torque to be transmitted by the safety coupling is transmitted from the latch ring to the sealing ring; and
in the overload state, the beveled lateral edges produce an axial force that is directed against the action of the spring device, in such a way that the latch ring is displaced axially in the direction of the toothed drive wheel and the latch toothings disengage.

7. The percussion and/or drill hammer as recited in claim 5, wherein the toothed drive wheel and the latch ring each have entraining claws that constantly engage in one another in such a way that the toothed drive wheel and the latch ring are fixed to one another in the circumferential direction, but are capable of being displaced towards one another in the axial direction.

8. The percussion and/or drill hammer as recited in claim 5, wherein
the toothed drive wheel is borne by a base sleeve, at least on a side facing away from the latch ring.

9. The percussion and/or drill hammer as recited in claim 1 wherein
at least a part of the latch device is capable of being moved axially relative to the sealing ring and/or relative to the toothed drive wheel.

10. The percussion and/or drill hammer as recited in claim 1, wherein the axial position of the toothed drive wheel and/or of the sealing ring is fixed in at least one axial direction.

11. The percussion and/or drill hammer as recited claim 1, wherein the toothed drive wheel and the sealing ring are situated on a base sleeve.

12. The percussion and/or drill hammer as recited in claim 11, wherein
the toothed drive wheel is positioned on the base sleeve so as to be capable of rotation; and
the sealing ring Ibis fastened on the base sleeve or is fashioned in one piece with the base sleeve.

13. The percussion and/or drill hammer as recited in claim 11, wherein
the toothed drive wheel is mounted on the base sleeve so as to be capable of rotation, or is fixedly attached thereto; and that
the sealing ring is mounted on the base sleeve so as to be capable of rotation.

14. The percussion and/or drill hammer as recited in claim 1, wherein the base sleeve is an integral component of the drill shaft or is part of a percussion mechanism tube.

15. The percussion and/or drill hammer as recited in claim 1, wherein a bearer sleeve is provided on which the safety coupling, in particular its base sleeve, is situated so as to be capable of rotational movement.

16. The percussion and/or drill hammer as recited in claim 15, wherein the bearer sleeve is part of the drill shaft.

17. The percussion and/or drill hammer as recited in claim 15, wherein the bearer sleeve is part of a percussion mechanism, in particular part of a percussion mechanism tube.

18. The percussion and/or drill hammer as recited in claim 15, wherein on the bearer sleeve there is provided a switching ring that is capable of being axially displaced in order to create or interrupt a flow of torque from the safety coupling to the bearer sleeve.

19. The percussion and/or drill hammer as recited in claim 18, wherein the switching ring is connected in rotationally fixed fashion to the bearer sleeve and has on at least one side switching claws to which there are allocated oppositely situated switching claws that are provided on a rear side of the sealing ring.

20. The percussion and/or drill hammer as recited in claim 18, wherein the switching ring is capable of being displaced at least between a drilling position, in which the switching claws of the switching ring engage with the switching claws of the sealing ring, and a free rotation position, in which the switching claws are not engaged.

21. The percussion and/or drill hammer as recited in claim 18, wherein
the switching ring has, on a rear side situated opposite the front side, fixing claws to which there are allocated oppositely situated fixing claws provided on a fixing ring that is connected fixedly to the housing; and
the switching ring is capable of being displaced into a fixing position in which the fixing claws of the switching ring engage with the fixing claws of the fixing ring.

22. The percussion and/or drill hammer as recited in claim 18, wherein the switching ring is capable of being displaced by a switching device that can be operated on an external side of the percussion and/or drill hammer.
